(19) United States
(12) Patent Application Publication
(10) Pub. No.: US 2016/0021437 A1
(43) Pub. Date: Jan. 21, 2016

(54) SEMICONDUCTOR COMPONENT SYSTEM WITH WIRELESS INTERCONNECT AND ARRANGEMENTS THEREFOR

(71) Applicant: Christian Stroetmann, Moers (DE)

(72) Inventor: Christian Stroetmann, Moers (DE)

(21) Appl. No.: 14/797,153

(22) Filed: Jul. 12, 2015

(30) Foreign Application Priority Data
Jul. 13, 2014 (DE) 20-2014-103-217.7

(51) Int. Cl. H04Q 11/00

(52) U.S. Cl. CPC H04Q 11/0005; H04Q 11/0071; H04Q 2011/0058; H04Q 2011/0007

(57) ABSTRACT

Embodiments of an integrated semiconductor component system are disclosed to solve both the interconnect bottleneck problem and the wiring problem simultaneously on the microscale of integrated semiconductor devices and on the macroscale of single computing systems consisting of integrated semiconductor devices by arranging single integrated semiconductor devices of an integrated semiconductor component system, or single integrated semiconductor component systems with the same distance from a center point in a geometric space. Furthermore, a working model to simulate entanglement of quantum based computing devices is provided.

### CROSS-REFERENCE TO RELATED APPLICATION

This application claims the benefit of the German Utility Model Application No. 20-2014-103-217.7, filed Jul. 13, 2014, and entitled “Integrierter Halbleiterbaustein, der mindestens drei unabhängige integrierte Systemkomponenten besitzt”, which is hereby incorporated by reference in its entirety.

### BACKGROUND

1. Field of the Disclosure

The present application relates generally to computing devices and systems composed of semiconductor devices. More particularly, the present invention pertains basic semiconductor devices, such as multi-core microprocessors, massively parallel processor arrays, multiprocessor systems on a chip, multi-core and many-core systems on a chip, and multi-processor systems in a package, and also multi-processor computer systems, specifically parallel computers, as well as to related electromagnetical wireless intra-chip or on-chip interconnects and networks, and inter-chip or off-chip networks, as well as combinations of such electromagnetical wired and wireless interconnects and networks connecting the independent semiconductor components of such computing systems.

2. Description of the Related Art

The present application relates generally to computing devices and systems composed of semiconductor devices. More particularly, the present invention pertains basic semiconductor devices, such as multi-core microprocessors, massively parallel processor arrays, multiprocessor systems on a chip, multi-core and many-core systems on a chip, and multi-processor systems in a package, and also multi-processor computer systems, specifically parallel computers, as well as to related electromagnetical wireless intra-chip or on-chip interconnects and networks, and inter-chip or off-chip networks, as well as combinations of such electromagnetical wired and wireless interconnects and networks connecting the independent semiconductor components of such computing systems.

One approach to solve the interconnect bottleneck problem on the microscale is to replace the electrical or metal respectively wired interconnects and electrical networks on a chip with optical (wired) interconnects and optical networks on a chip.

Various system designs with optical interconnects are proposed for different reasons including for example (a) a hybrid network for multi-processor systems on chip comprising a mesh electrical network and an optical ring network to transfer short control messages for reducing the control delay in cache coherence protocols, (b) an optical ring waveguide to replace global pipelined electrical interconnects providing more uniform latency and throughput compared with the mesh network, (c) a hierarchical optical rings, where local rings are used for intra-node communication and global rings are to connect the nodes, (d) an optical torus network with related network protocols and floorplanning, (e) an optical ring network on a chip for both two-dimensional and three-dimensional system architectures, (f) physical layouts of different wavelength-routed on-chip optical networks, and (g) an architecture which uses optical interconnects for both intercore communication and off-stack communication to memory with the cores integrated as clusters, which are fully interconnected with a photonic crossbar, and distributed optical token-based arbitration scheme is proposed for channel allocation.

But because solving the interconnect bottleneck problem with optical interconnects does neither solve the fundamental bandwidth density challenge for the in-plane waveguided optical interconnect approach nor the wiring problem in general, an approach to solve the optical interconnect bottleneck problem and the wiring problem is to replace these wired interconnects and networks on the microscale as well as the interconnects and networks on the macroscale with electromagnetical wireless interconnects and networks, such as (free space) optical wireless interconnects and networks.

Various system designs with free-space optical (wireless) interconnects are proposed for different reasons including for example (h) an optical network on a chip based on free-space optical interconnects to reduce power consumption, (i) an intra-chip free-space optical interconnect with three-dimensional system architecture, and (j) an on-chip free-space optical network with wavelength switching. A single light beam is analogous to a single wire and similarly, an array of vertical cavity surface emitting lasers (VCSELs) can form essentially a multi-bit bus, which is called a lane sometimes. An interesting feature of using free-space optics is that signaling is not confined to fixed, prearranged waveguides and the optical path can change relatively easily.

A specific representative example of the direction of the technological development in this field is the approach to construct three-dimensional integrated chip stacks 100 as shown in FIG. 1 having a three-dimensional system architecture with an optical substrate respectively free-space optical communication layer 130, consisting of arrays of laser devices 122, micro-optics devices such as micro-mirrors 126 and micro-lenses 128, mirroring surface 132 at the package top 102, and photodector devices 124 for providing an intra-chip or on-chip free space optical wireless interconnect or network on chip, which is superimposed on top of a common CMOS substrate 111 respectively CMOS electronics layer 110 via three-dimensional chip integration. In such a free-space optical interconnect system, three-dimensional integration technologies are applied to electrically connect the free space layer 130 with the photonics layer 120 based on flip-chip bonding 104 for example and the photonics layer 120 with the electronics layer 110 based on through-silicon vias 112, forming an electro-optical system in a package (SiP) 100.

In one particular system design, digital data streams modulate an array of lasers. Each modulated light beam emitted by a laser can be collimated by a microlens, guided by a series of micro-mirrors, focused by another micro-lens, and then detected by a photodetector. The received electrical signals are finally converted to digital data. In another system design as shown in FIG. 1, a group of vertical cavity surface emitting lasers (VCSELs) 122 can be used to form an optical phase array (OPA), which is essentially a single tunable-direction laser. This system design makes an all-to-all network topology much easier to implement. With mirror-guided or phase array-based beamsteering 150, (dynamic) optical communication channels are built directly between communicating nodes within the network in a totally distributed fashion.

By utilizing the beamsteering capability 150 of an optical phase array (OPA) of lasers, the number of lasers and photodetectors in each node can be constant, providing further flexibility and scalability.

In general, such electro-optical SiPs increase the speed of communication, because the optical links are running at multiples of the core clock speed, and reduce the latency and power consumption of the global signaling through free-space optical interconnect, while permitting the microprocessors to be implemented using standard CMOS technologies.

Another approach to solve the wiring problem on the macroscale and to overcome the barriers of power consumption, memory and storage bandwidth, and also reliability and resiliency, specifically in relation with large computing systems, such as data centers and supercomputers or high performance computing systems for example, is to depart from the arrangement of server racks in rows in favour of a circular arrangement.

As part of the initiative “Oak Ridge Leadership Computing Facility” (OCLF) of the U.S. Department of Energy a national laboratory designed a high performance computing system 200 called OCLF-5 shown in FIG. 2, that has rings with the access points, such as 212, 214 for example, to the high performance computer system 210, with the server racks for the computing nodes 220, and with the intermediate computing and network devices 230 and 240, which are circularly arranged around an array of spherical network switches 250, such as network switch 252, at the center axis of these rings 210 to 240 with the rings 220 and 230 connected by wired links, such as the connection 254, the rings 230 and 240 connected by wired links, such as the connection 256, and the ring 240 with axis array 250 connected by wired links, such as the connection 258.

As part of the research project “On the Feasibility of Completely Wireless Datacenters”, a datacenter with a novel rack design and a resulting network topology inspired by Cayley graphs is proposed that provide a dense interconnect and the opportunity to solve both the interconnect problem and the wiring problem on the macroscale. In this design even the computing nodes are circularly arranged within the server racks, and the wired network or interconnect is substituted with a wireless network by installing 60 GHz radio frequency transceiver devices and Y-switch devices into each computing node.

The exploration of the resulting design space shows that wireless datacenters and also other such large computing systems built with this methodology can potentially attain higher aggregate bandwidth, lower latency, and substantially higher fault tolerance than a conventional wired datacenter and also improve ease of construction and maintenance.

Electromagnetical (wireless) interconnects and networks, specifically optical interconnects and networks, have fundamental advantages compared to electrical and optical wired interconnects and networks, particularly in power consumption respectively energy efficiency, delay respectively latency, potential bandwidth, and fault tolerance respectively reliability and resiliency, and in addition offer a new set of opportunities. But while signaling issues have received a lot of attention, networking issues in the general-purpose domain remain under-explored. Furthermore, intra-chip or on-chip interconnects and networks pose different constraints and challenges from inter-chip or off-chip interconnects and networks. Therefore architecting intra-chip or on-chip interconnects and networks for future microprocessors and computers as well as architecting inter-chip or off-chip interconnects and networks for future single computer systems including single computing nodes of large computing system clusters require novel solutions and deserves more attention, as it is also the case with computing systems based on integrated semiconductor devices.

Observing the technological development in the area of multi-core and many-core processing systems, it becomes obvious that also the wiring problem will affect the computing systems on the microscale in the same way as it affected the computing systems on the macroscale already. However, an integration of the solutions for the interconnect bottleneck problem applied on the microscale and the wiring problem applied on the macroscale as discussed above is missing. Furthermore, no foundationally new possibilities are given.

### BRIEF SUMMARY

Accordingly, the invention is a continuation of the past technological development on the microscale and the macroscale of computing devices and computing systems. As another approach to solve both the interconnect bottleneck problem and the wiring problem simultaneously on the microscale of integrated semiconductor devices and on the macroscale of single computing systems consisting of integrated semiconductor devices, such as for example a high performance computing system with a wireless interconnect on a chip or in a package, and a high performance computing system on a base board or a motherboard, the single integrated semiconductor devices of an integrated semiconductor component system or the single integrated semiconductor component systems are arranged with the same distance from a center point in a geometric space.

Related wireless interconnects and networks comprise at least one transmitter device and at least one receiver device, which are configured to work on one of the (a) radio wave band, (b) microwave band, (c) infrared radiation band, (d) light radiation band, (e) ultraviolet radiation band, or (f) roentgen radiation band. Maser and laser devices, but also projector devices are used as transmitter devices and various types of photodetectors are uses as receiver devices.

The ways of physical connection reflects the ways of network communication unicast (one-to-one), multicast (one-to-unique many or unique many-to-unique many), broadcasting (one-to-many), anycast (one-to-nearest), and all-to-all.

Furthermore, by using multiple transmitters and multiple receivers at a network node multipath propagation can be exploited, such as multiple-input and multiple-output (MIMO), including (a) single user MIMO or multi-antenna MIMO, (b) multi-user MIMO (MU-MIMO), (c) partial full multi-user MIMO or multi-user and multi-antenna MIMO, (d) full multi-user MIMO, cooperative MIMO (CO-MIMO) or network MIMO (Net-MIMO), and (e) cognitive MIMO, as well as MIMO enhancements.

To exploit the many possibilities it is highly advantageous to let the integrated semiconductor component system handle the communication management as well by using for example programmable digital radio, software-defined radio (SDR) and advanced variants, such as cognitive radio for example that are based on intelligent techniques and own functionalities.

But the intentions and directions behind the disclosed invention are many-folded going beyond common computing systems.

Several free-space optical interconnect system architectures provide all-to-all direct communication links between processor cores, regardless of their topological distance. In contrast, the independent integrated system components of the disclosed computing system are arranged with the same distance from a center point with respect to a geometric space, such as the Euclidian space, or described in other words they are arranged on a square or a circle in a two-dimensional plane or in on a cube, a cylinder, or a sphere in a three-dimensional space for example.

By directly using a specific topology the knowledge about the exact positions of system components are implicitly given by the chosen topology within tolerance of manufacturing, which can be used for further optimizations of the integrated semiconductor component system by incorporating the knowledge about the wave-lengths and run-lengths of the communication path and carrier into the working of the communicating components and also of the processing components.

In the case that an arrangement respectively a topology and the related positions respectively distances and angles are not exactly known in general, due to tolerances by the production process in particular, or/and can be moved or changed, then methods for calibrating the device can be applied, for example by sending a test signal.

The disclosed invention also comprises combinations of optical wired interconnects and networks with free-space electromagnetical wireless interconnects and networks, such as the combination of optical wired interconnects and networks to free-space optical wireless interconnects and networks, and means therefore.

The different interconnects and networks can also be used for the configuring of the senders and receivers of the integrated semiconductor component system, the time synchronization system (e.g., using optical clock distribution), so that no clock recovery circuit is needed, for sending a test signal back to the sender, and for providing other support.

Some embodiments of the disclosed system also provide a connection with external device, including mobile devices including smartphone, tablet computer, laptops, and connected vehicles, head-mounted displays, computer systems for example, by optical wired and electromagnetical wireless communication interfaces.

A further aspect behind the invention is to construct a high performance computing system as a model of a quantum computer and a real quantum computer. By changing from Euclidean space to Hilbert space, which generalizes the notion of Euclidean space, and applying the feature of multi-casting the quantum computer model should be able to simulate entanglement.

The invention may be implemented in numerous ways. In this conjunction, all the components or electronic units, which form the various parts of said integrated semiconductor component system and which are known to those skilled in the art in the field of computer engineering, will not be described in detail. Only said components necessary to the elaboration of preferred embodiments of an integrated semiconductor component system according to the invention will be described.

Other systems, methods, features, advantages, objects, and further areas of applicability together with a more complete understanding of the disclosure will be, or will become, apparent and appreciated to one with skill in the art upon examination of the following figures and detailed description, or may be learned by practice of the present invention. It is intended that all such additional systems, methods, features, and advantages be included within this description, be within the scope of the present disclosure, and be protected by the following claims. Nothing in this section should be taken as a limitation on those claims. Further aspects and advantages are discussed below in conjunction with the embodiments. It is to be understood that both the foregoing general description and the following detailed description of the present disclosure are exemplary and explanatory and are intended to provide further explanation of the disclosure as claimed, but are not intended to limit the scope of the disclosure.

### BRIEF DESCRIPTION OF THE DRAWINGS

The accompanying drawings, which are included to provide a further understanding of the disclosure and are incorporated herein and constitute a part of this application, illustrate embodiment(s) of the disclosure and together with the description serve to explain the principle of the disclosure. In the drawings:

FIG. 1 illustrates a sectional side view of a three-dimensional system in a package with free-space optical interconnect in accordance to a first prior art;

FIG. 2 illustrates a perspective view of a high performance computing system with circular arrangement of the system components in accordance to second prior art;

FIG. 3A illustrates a front view of an example configuration of an integrated semiconductor component system according to a first embodiment that can be used in accordance with various embodiments;

FIG. 3B illustrates a side view of the example configuration of an integrated semiconductor component system shown in FIG. 3A;

FIG. 4A illustrates a front view of an example configuration of an integrated semiconductor component system according to a second embodiment that can be used in accordance with various embodiments;

FIG. 4B illustrates a side view of the example configuration of an integrated semiconductor component system shown in FIG. 4A;

FIG. 5 illustrates a top view of an example configuration of an integrated semiconductor component system with a circular arrangement according to a third embodiment;

FIG. 6 illustrates a top view of an example configuration of a circuit board with integrated semiconductor component system with a circular arrangement and shape according to a fourth embodiment;

FIG. 7 illustrates a top view of an example configuration of a circuit board with integrated semiconductor component systems according to a fifth embodiment;

FIG. 8A illustrates a side view an example of a circuit board with integrated semiconductor component system and key, and a related slot according to a sixth embodiment;

FIG. 8B illustrates a top view of an example mainboard for the circuit board with integrated semiconductor component system shown in FIG. 8A; and

FIG. 9 illustrates a perspective view of an example configuration of a stack of circuit boards with integrated semiconductor component systems with a cylindrical arrangement.

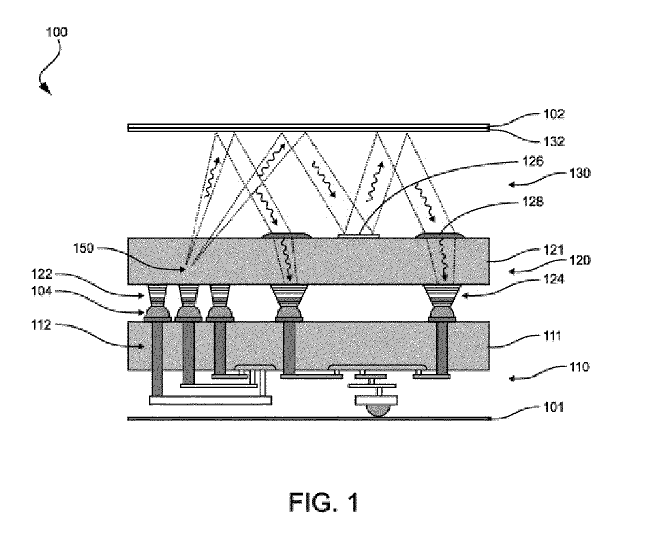

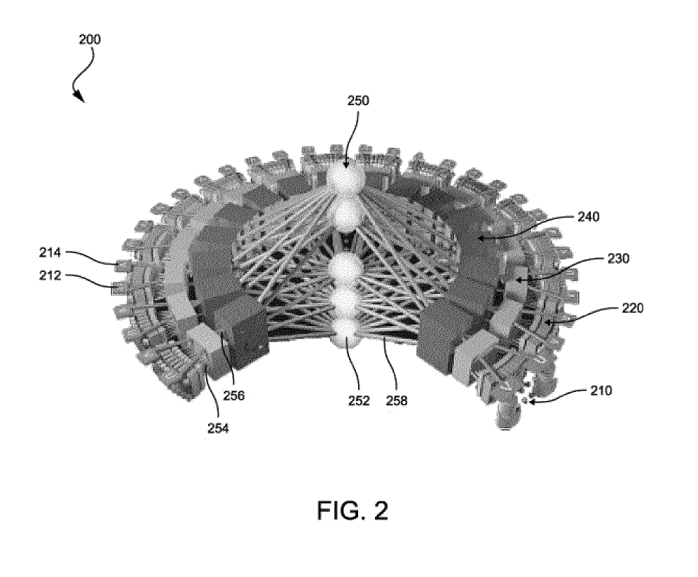

### DETAILED DESCRIPTION OF THE INVENTION

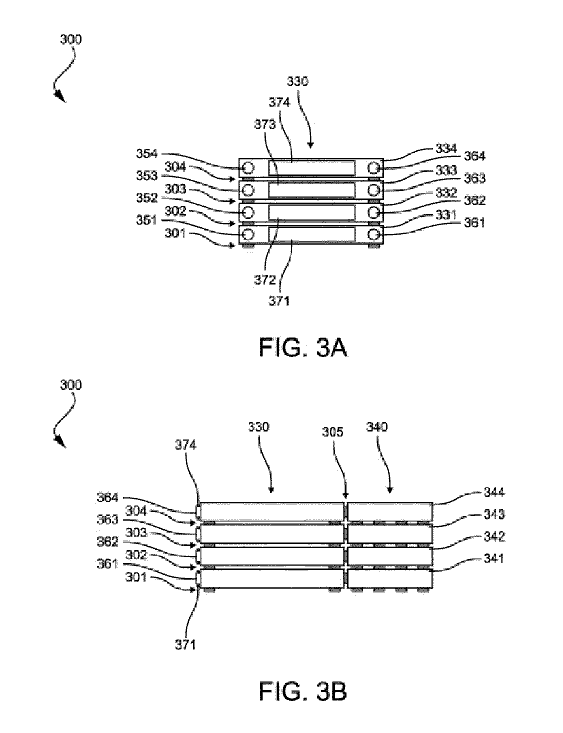

FIGS. 3A and 3B schematically illustrate a first preferred embodiment of an integrated semiconductor component system in a three-dimensional package 300. The integrated semiconductor component system 300 comprises a stack of processors 330 with single integrated semiconductor components on CMOS substrate layers 331 to 334, and a stack of random access memory devices 340 with single integrated semiconductor components on CMOS substrate layers 341 to 344.

By three-dimensional chip integration the single component layers 331 to 334 and 341 to 344 are horizontally connected with each other by the through-silicon via layers 302, 302, and 304, and superimposed on top of a package substrate by a flip-chip bonding layer 301 for example. The semiconductor component stacks 330, 340 are vertically connected with each other by the chip integration layer 305.

In this example, the stack of processors 330 also comprises transmitter modules 351 to 354 and receiver modules 361 to 364, which are directly integrated into the single integrated semiconductor component layers 331 to 334. In some variants of the embodiment the transmitter and receiver modules can be radio frequency transmitter devices and antennas, microwave transmitter and receiver modules, optical transmitter and receiver modules respectively optical transceiver devices. In the case of optical transmitter and receiver devices, and transceiver devices the component layers of the stack of processors 330 can also have micro-mirrors 371 to 374.

Although only the transmitter modules 351 to 354 and receiver modules 361 to 364 are illustrated in this example, it should be understood that within the scope of the various embodiments there can be additional or alternative transmitter and receiver components and devices of the same or a different type, such as transceiver devices working in same ranges of the electromagnetical spectrum.

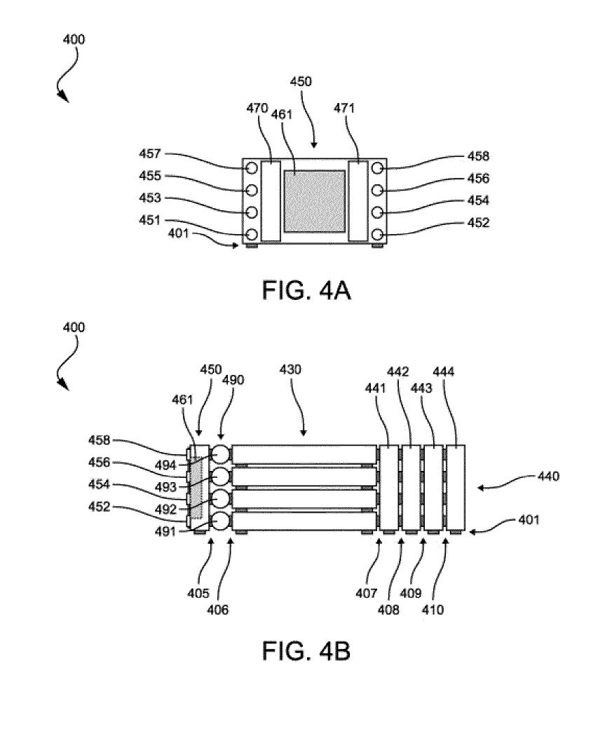

FIGS. 4A and 4B schematically illustrate a second preferred embodiment of an integrated semiconductor component system in a three-dimensional package 400. The integrated semiconductor component system 400 comprises a stack of processors 430 with single integrated semiconductor components on CMOS substrate layers 431 to 434, a stack of random access memory devices 440 with single integrated semiconductor components on CMOS substrate layers 441 to 444, an integrated semiconductor layer 450, and a stack of optical interconnects 490 with optical waveguides 491 to 494.

By three-dimensional chip integration the single component layers 431 to 434 are horizontally connected with each other by the through-silicon via layers 402, 403, and 404, and the single component layers 441 to 444 are vertically connected with each other by the through-silicon via layers 408, 409, and 410. The component layers 431 to 434, 441 to 444, and 450 are superimposed on top of a package substrate by a flip-chip bonding layer 401 for example. The semiconductor component stacks 430, 440 are vertically connected with each other by the chip integration layer 407, the semiconductor component stack 430 and the optical interconnect stack 490 are vertically connected with each other by the chip integration layer 406, and the semiconductor layer 450 and the optical interconnect stack 490 are vertically connected with each other by the chip integration layer 405.

In this example, the semiconductor layer 440 also comprises transmitter modules 441 to 448 and a photo detector 451 configured as a receiver device, which are directly integrated into the single semiconductor layer 440. In the case of optical transmitter and receiver devices the semiconductor layer 440 can also have micro-mirrors 470, 471.

Although only the photo detector 451 is illustrated in this example, it should be understood that within the scope of the various embodiments there can be additional or alternative photo detector components and devices of the same or a different type, such as a grid of photo diodes, a charged-coupled device, or an active pixel sensor device, such as a CMOS imager device.

The numbering of the single integrated semiconductor components on CMOS substrate layers 421 to 424 and the single through-silicon via layers 402, 403, and 404 are not numbered in the FIGS. 4A and 4B for better illustration.

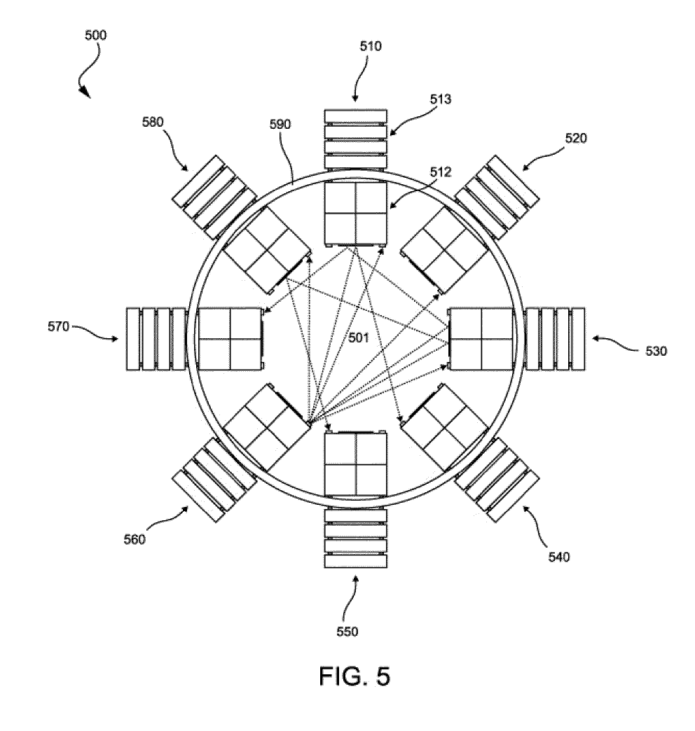

FIG. 5 schematically illustrate a third preferred embodiment of an integrated semiconductor component system with a circular arrangement 500. The integrated semiconductor component system 500 comprises single three-dimensional integrated semiconductor component devices 510 to 580, such as the device described in FIGS. 3A and 3B for example, that are circularly arranged on a package substrate not shown in the FIG. 5. The semiconductor component devices 510 to 580 are connected by a ring-shaped optical interconnect 590 and a free-space optical wireless interconnect.

In this example, the integrated semiconductor component devices 510 to 580 also communicate through a free-space optical wireless interconnect that provides an all-to-all communication. As it is illustrated by the dotted arrows 501, the semiconductor component device 560 can directly sent data to and receive data from the semiconductor component devices 510, 520, 530, and 580, indirectly sent data to and receive data from the semiconductor component device 540 over one or more micro-mirrors of the semiconductor component device 510, and indirectly sent data to and receive data from the semiconductor component devices 550 and 570 over at least two micro-mirrors of semiconductor component devices 530 and 510.

In modifications of the embodiment shown in FIG. 5 the integrated semiconductor component devices 510 to 580 can have radio frequency transmitter and receiver devices, and transceiver devices.

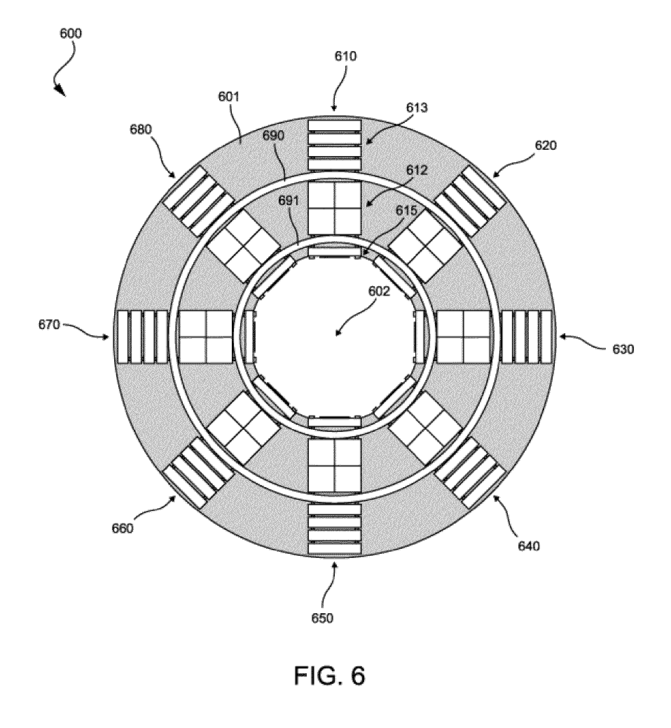

FIG. 6 schematically illustrate a fourth preferred embodiment of an integrated semiconductor component system with a circular arrangement 600. The integrated semiconductor component system 600 comprises single three-dimensional integrated semiconductor component devices 610 to 680, such as the device described in FIGS. 4A and 4B for example, that are circularly arranged on a package substrate 601. The semiconductor component devices 610 to 680 are connected by ring-shaped optical interconnects 690, 691 and a free-space optical wireless interconnect.

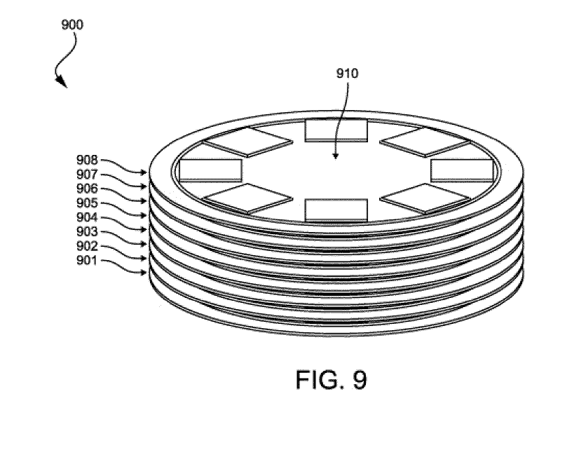

In this example, the package substrate 601 has a hole 602 at the area of the free-space optical wireless interconnect, so that cylindrical stacks of the integrated semiconductor component system 600, as shown in FIG. 9, can communicate with their free-space optical wireless interconnect over several stacks in three dimensions as well.

The free-space communication functions in the same way as described in relation with the third embodiment illustrated FIG. 5, so that a detailed description can be omitted here.

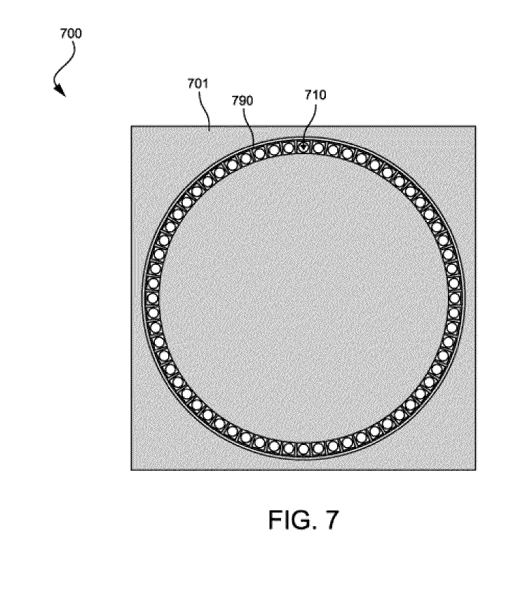

FIG. 7 schematically illustrate a circuit board with integrated semiconductor component systems 700 in accordance to a fifth preferred embodiment. The ring of integrated semiconductor component systems 710 circularly arranged on a circuit board 701 and connected by ring-shaped optical interconnects 790 and a free-space optical wireless interconnect. The circuit board 701 can be a motherboard of a single computing device or a rackmount system for a server rack of a large computing system.

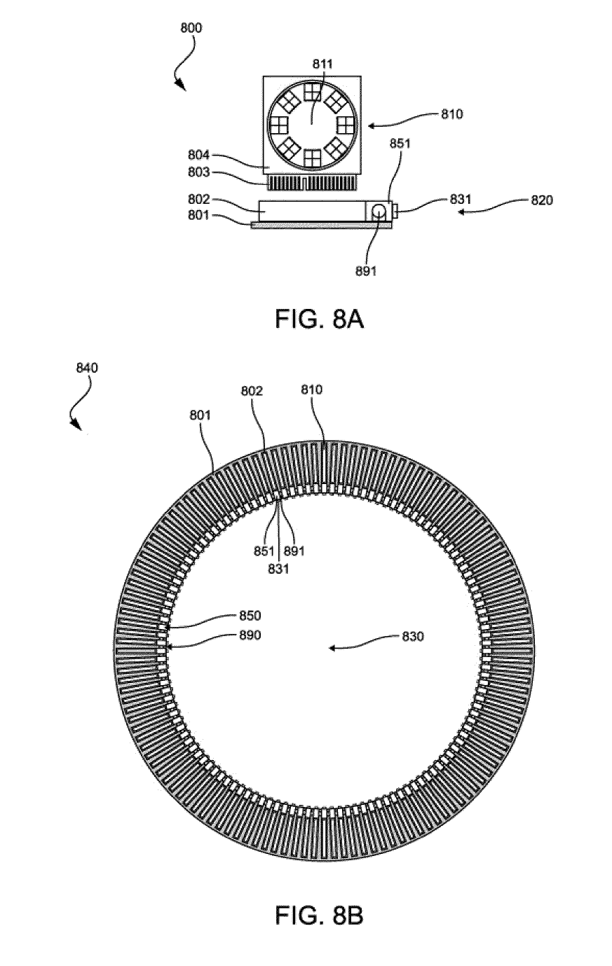

FIGS. 8A and 8B schematically illustrate a circuit board with integrated semiconductor component system 800, and a related socket means 820 and a circuit board configured as a backplane 840 in accordance to a sixth preferred embodiment. A single integrated semiconductor component system 800 comprises an integrated semiconductor component system 811 built on a circuit board 804 with a key area 803.

A single socket means 820 comprises a socket with a slot 802 mounted on the circuit board 801 and an optical switching box device 851 with a transceiver device 831 of a free-space electromagnetical interconnect or network 830 and a connection to a waveguide 891 of an optical wired interconnect or network 890. The slot 802 and the key area 803 are shaped in a form-locking way, so that the integrated semiconductor component system 800 can be plugged into the socket 820 and provided with electric power and connectivity to the communication means of the circuit board 840.

The circuit board 840 comprises the free-space communication area 830, a ring with optical switching box devices 850, and the optical wired interconnect or network ring 890. The circuit board 840 is shaped as a ring.

An optical switching box device 851 connects the optical waveguide 891 of the optical wired interconnect or network ring 890 with the transceiver device 831 of the electromagnetical wireless interconnect or network 830. In this example, the optical switching box device 851 includes at least one Y-switch device that on the one side is connected with the transceiver device 831 and on the other side with one or more microresonator devices which are connected with the optical waveguide 891. The Y-switch device and the microresonator device are not shown in FIG. 8 for better illustration, but a person ordinary skilled in the art should be able to realize such a optical switching box device without any problems.

In modifications of the embodiment shown in FIG. 8A the single integrated semiconductor component system 810 on the circuit board 804 can have a means for the electromagnetical wireless interconnect or network or/and in addition a wireless communication interface device to connect with other computing devices that belong to the same computing system or/and are external electronically operated devices. Furthermore, the socket means comprising a key and a slot can be constructed on the base of optical components as well.

In other modifications, the embedded system 810 could also be a common embedded computing system without any optical wired or wireless interconnect or network or/and also have a cooling system.

FIG. 9 illustrates an example stack of circuit boards 900 that comprises the single circuit boards with integrated semiconductor component systems 901 to 908, such as the devices described in FIGS. 5, 6, and 7. for example, which are cylindrically arranged in three dimensions. Depending on its scale, the stack can be a three-dimensional system in a package in the case of a microsystem or a three-dimensional cluster of computing systems with multiple integrated semiconductor component systems in the case of a macrosystem.

The specification and drawings are to be regarded in an illustrative rather than a restrictive sense. It will, however, be evident that various modifications and changes may be made thereunto by those skilled in the art without departing from the broader spirit and scope of the invention as set forth in the claims. In other words, although embodiments have been described with reference to a number of illustrative embodiments thereof, this disclosure is not limited to those. Accordingly, in various embodiments of the invention the various embodiments of the integrated semiconductor component system discussed and suggested in FIGS. 3A, 3B, 4A, 4B, 5, 6, 7, 8A, 8B, and 9 can be combined with each other in appropriate ways. The scope of the present disclosure shall be determined only by the appended claims and their equivalents. In addition, variations and modifications in the component parts, arrangements, or/and alternative uses must be regarded as included in the appended claims.

1. An integrated semiconductor component system, comprising:
at least three independent integrated system components being semiconductor devices; and
at least one intranetwork being configured to connect said independent integrated system components with one another,
wherein said independent integrated system components are arranged with the same distance from a center point in a geometric space.

2. The integrated semiconductor component system of claim 1,
wherein the integrated semiconductor component system is one of (a) a chip, (b) a system on a chip or system on chip (SoC), (c) a multi-core system on a chip, (d) a many-core system on a chip, (e) a multiprocessor system on a chip or multiprocessor system on chip (MPSoC), (f) a system in a package or system in package (SiP), or (g) a multiprocessor system in a package or multiprocessor system in package (MPSiP).

3. The integrated semiconductor component system of claim 1,
wherein at least one independent integrated system component is one of (a) a chip, (b) a system on a chip or system on chip (SoC), (c) a multiprocessor system on chip (MPSoC), (d) a system in a package or system in package (SiP), or (e) a multiprocessor system in a package or multiprocessor system in package (MPSiP).

4. The integrated semiconductor component system of claim 1,
wherein at least one of the independent integrated system components comprises:
at least one microprocessor comprising:
at least one processing unit or core.

5. The integrated semiconductor component system of claim 4,
wherein at least one microprocessor is one of (a) a clocked or synchronous processing unit, (b) a clockless or asynchronous processing unit, (c) a graphics processing unit, (d) a physics processing unit, or (e) a content addressable processing unit or associative processing unit.

6. The integrated semiconductor component system of claim 1,
wherein at least one independent integrated system component comprises:
at least one field-programmable gate array (FPGA).

7. The integrated semiconductor component system of claim 1,
wherein at least one independent integrated system component comprises:
at least one integrated circuit being configured as a primary computer data storage or computer memory device.

8. The integrated semiconductor component system of claim 7,
wherein at least one primary computer data storage or computer memory device includes one of (a) a random access memory (RAM), (b) a volatile random access memory, (c) a non-volatile random access memory (NVRAM), or (d) a content addressable memory (CAM) or associative memory.

9. The integrated semiconductor component system of claim 1,
wherein at least one independent integrated system component is a three-dimensional integrated circuit.

10. The integrated semiconductor component system of claim 9,
wherein at least one three dimensional integrated circuit includes (a) at least two bare semiconductor-chips or dies of a processor stacked to a processor stack, (b) at least two processor stacks stacked to a stack of processor stacks, (c) at least two bare semiconductor-chips or dies of a volatile random access memory stacked to a volatile random access memory cube, (d) at least one bare semiconductor-chip or die of a volatile random access memory stacked on a bare semiconductor-chip or die of a processor, (e) at least one volatile random access memory stacked on a processor, (f) at least one non-volatile random access memory cube stacked on a processor, (g) at least one volatile random access memory cube stacked on a processor stack, (h) at least one volatile random access memory cube stacked on a stack of processor stacks, (i) at least two bare semiconductor-chips or dies of a non-volatile random access memory stacked on a non-volatile random access memory cube, (j) at least one bare semiconductor-chip or die of a non-volatile random access memory stacked on a bare semiconductor-chip or die of a processor, (k) at least one non-volatile random access memory is stacked in three dimensions on a processor, (l) at least one non-volatile random access memory cube stacked on a processor, (l) at least one non-volatile random access memory cube stacked on a processor stack, or (m) at least one a non-volatile random access memory cube stacked on a stack of processor stacks.

11. The integrated semiconductor component system of claim 1, further comprising:
wherein at least one intranetwork is one of (a) an intra-chip interconnect, (b) a network on a chip or network on chip (NoC), (c) an inter-chip interconnect respectively intra-system on chip network, (d) an intra-system in package network, (e) an inter-system on chip network, or (f) an inter-system in package network.

12. The integrated semiconductor component system of claim 1,
wherein at least one intranetwork is configured as a wired intranetwork comprising:
at least one network switch device.

13. The integrated semiconductor component system of claim 12,
wherein at least one wired intranetwork is configured as an optical network.

14. The integrated semiconductor component system of claim 13,
wherein at least one independent integrated system component comprises:
at least one microresonator device.

15. The integrated semiconductor component system of claim 1,
wherein at least one intranetwork is configured as a wireless intranetwork comprising:
at least one transmitter device being configured to transmit data by electromagnetic radiation, and
at least one receiver device being configured to receive data by electromagnetic radiation.

16. The integrated semiconductor component system of claim 15,
wherein at least one transmitter device of the wireless intranetwork comprises one of (a) a light emitting diode device, (b) a maser device, (c) a laser device, or (d) a projector device.

17. The integrated semiconductor component system of claim 15,
wherein at least one receiver device of the wireless intranetwork comprises one of (a) a photodiode device, (b) a charge-coupled device (CCD), or (c) an active pixel sensor device.

18. The integrated semiconductor component system of claim 1,
wherein at least one transmitter device and at least one receiver device are integrated to a full-duplex device.

19. The integrated semiconductor component system of claim 1,
wherein at least one independent integrated system component comprises:
a Y-switch device being directly connected with at least one receiver device and being able to pass through received data to a next integrated semiconductor component system.

20. The integrated semiconductor component system of claim 1, further comprising:
a wired internetwork to at least one other integrated semiconductor component system.

21. The integrated semiconductor component system of claim 1, further comprising:
a wireless internetwork to at least one other integrated semiconductor component system.

22. The integrated semiconductor component system of claim 1, further comprising:
a wireless communication interface device being configured to transmit and receive electromagnetic radiation, and to connect with other electrically operated devices,
wherein said wireless communication interface device is connected to at least one independent integrated system component.

23. The integrated semiconductor component system of claim 1, further comprising:
a cooling system.

24. The integrated semiconductor component system of claim 23,
wherein the cooling system includes at least one of (a) a fan, (b) a heat pipe, (c) a closed cycle means with liquid coolant, or (d) a waste heat recovery system being based on the thermoelectric effect.

25. The integrated semiconductor component system of claim 1,
wherein the geometric space in which the independent integrated system components are arranged is one of (a) the Euclidian space or (b) the Hilbert space.

26. The integrated semiconductor component system of claim 25,
wherein each pair of adjacent independent integrated system components are arranged with the same distance to each other.

27. The integrated semiconductor component system of claim 1,
wherein the independent integrated system components are mounted on a circuit board, said circuit board comprising:
at least one conductive contact member being configured to plug-in the circuit board into a related slot of a socket mounted on another circuit board.

28. An integrated semiconductor component system, comprising:
at least two independent integrated system components being semiconductor devices;
at least one optical wireless intranetwork being configured to connect said independent integrated system components with one another; and
at least one optical wired intranetwork being configured to connect said independent integrated system components with one another.

29. A circuit board, comprising:
at least three socket means each being configured to receive one circuit board having at least one integrated semiconductor component system built on it; and
at least one network being configured to connect plugged-in circuit boards with one another,
wherein said socket means are arranged with the same distance from a center point in the Euclidian space.
